(19) United States
(12) Patent Application Publication
(10) Pub. No.: US 2004/0135962 A1
(43) Pub. Date: Jul. 15, 2004

(54) Liquid crystal device exhibiting optical properties which are changeable after assembly

(76) Inventors: Matthias Kuntz, Seeheim-Jugenheim (DE); Robert Hamond-Smith, Dammerham (GB); Rodney Riddle, Dorset (GB); John Patrick, Dorset (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/475,714

(22) PCT Filed: Mar. 30, 2002
(86) PCT No.: PCT/EP02/03563

(30) Foreign Application Priority Data
Apr. 24, 2001 (EP) 01109446.3

(51) Int. Cl. C09K 19/02

(52) U.S. Cl. 349/183

(57) ABSTRACT

The invention relates to a liquid crystal device comprising a liquid crystal material provided between two substrates. The invention further relates to methods of providing such a liquid crystal device and to its use for decorative, cosmetic, diagnostic and security applications or for optical information storage.

### FIELD OF THE INVENTION

The invention relates to a liquid crystal device comprising a liquid crystal material provided between two substrates. The invention further relates to methods of providing such a liquid crystal device and to its use for decorative, cosmetic, diagnostic and security applications and optical information storage.

### BACKGROUND AND PRIOR ART

The properties of liquid crystal materials and their use in particular in security and decorative devices and applications have been described in prior art. The main properties that have potential in the decorative or security device area are the birefringence of nematic liquid crystal mixtures, the selective wavelength reflection of chiral liquid crystals, in particular chiral nematic (cholesteric) liquid crystals, and the thermochromic effect.

U.S. Pat. No. 4,834,500 discloses a thermochromic liquid crystal device comprising a layer of short pitch cholesteric liquid crystal material between two flexible walls. At least one of the flexible walls has a surface profiled with a fine grating, for example a series of fine grooves and ridges, to achieve high colour purity and low reflectance.

GB 2 197 109 discloses a laminated product, such as a thermometer or security card, comprising two sheets that are bound together by means of an adhesive and contain a thermochromic liquid crystal material, preferably an ink with encapsulated thermochromic material.

CN 1138523 discloses a decorative thermochromic liquid crystal membrane obtained by coating a liquid crystal material onto a transparent substrate with a draw pattern, covering it with a polyester film and sealing it with thermosetting resin or paints.

U.S. Pat. No. 5,678,863 discloses a security marking for a document of value comprising a watermark coated with a cholesteric liquid crystal material producing optical effects which differ when viewed in transmitted and reflected light. The cholesteric liquid crystal material is for example an encapsulated liquid crystal mixture or a solid liquid crystal polymer.

GB 2 345 879 discloses a security article, such as a document, bearing information partly in a permanently visible form and partly in a liquid crystal or thermochromic ink which only becomes visible on subjecting the article to predetermined conditions, e.g. heat or pressure. The ink comprises microencapsulated thermochromic or liquid crystal material.

The use of liquid crystal materials as security devices in prior art has been limited by the need to prepare the substrates, materials or both to obtain a good effect and a durable device. Thus, the systems described in prior art require the liquid crystal material to be encapsulated like in GB 2 345 879 or U.S. Pat. No. 5,678,863, aligned by etching a substrate like in U.S. Pat. No. 4,834,500, adhesively bound to the substrate like in GB 2 197 109, sealed with a thermosetting resin like in CN 1138523 or applied in solid form like in U.S. Pat. No. 5,678,863. Also, the use of the security devices described in the above mentioned prior art documents is limited since the liquid crystal material is applied either in liquid or solid form, and the optical effects of the devices cannot be varied after the device has been manufactured.

### SUMMARY OF THE INVENTION

The aim of the present invention is to provide a durable liquid crystal device, in particular for decorative, cosmetic, diagnostic and security applications, that does not have the drawbacks of the prior art devices, is easy to manufacture and can be used in a broad variety of applications.

The inventors of the present invention have found that the above aims can be fulfilled by providing a liquid crystal device as described below.

One object of the invention is a liquid crystal device comprising a liquid crystal material laminated between two substrates, wherein the edges of the substrates are sealed to form a pocket.

Another object of the invention is a method of preparing a liquid crystal device as described above and below.

Another object of the invention is the use of a liquid crystal device as described above and below in decorative, cosmetic, diagnostic or security applications or for optical information storage.

Another object of the invention is a security marking or device comprising a liquid crystal device as described above and below.

Definition of Terms

The term ‘film’ as used in this application includes self-supporting, i.e. free-standing, films that show more or less pronounced mechanical stability and flexibility, as well as coatings or layers on a supporting substrate or between two substrates.

The term ‘liquid crystal or mesogenic material’ or ‘liquid crystal or mesogenic compound’ should denote materials or compounds comprising one or more rod-shaped, board-shaped or disk-shaped mesogenic groups, i.e. groups with the ability to induce liquid crystal phase behaviour. The compounds or materials comprising mesogenic groups do not necessarily have to exhibit a liquid crystal phase themselves. It is also possible that they show liquid crystal phase behaviour only in mixtures with other compounds, or when the mesogenic compounds or materials, or the mixtures thereof, are polymerised.

### DETAILED DESCRIPTION OF THE INVENTION

A first preferred embodiment of the present invention relates to a liquid crystal device wherein a liquid crystal (LC) material is coated onto a substrate, laminated with a second substrate and sealed at the edges at least partially to form a pocket containing the LC material. The final pockets produced by the inventive method can be custom made for specific applications. No thermal curing, photocuring, encapsulation or aligning is required, although additional application of one or more of these methods may impart some further benefit to the inventive devices.

A second preferred embodiment of the present invention relates to a liquid crystal device wherein a polymerisable LC material is provided between two substrates. This device has an added benefit in that it can be treated at a later date to invalidate the device or change its optical effects or the infomration inscribed therein, e.g. by photopolymerisation of the whole device or selected parts thereof. This is demonstrated further below.

The devices according to the present invention are not limited to application to a document of high value (e.g. bank note) but can be used as a stand alone device e.g. a product label which would be particularly applicable in the area of brand protection.

According to a preferred embodiment of the present invention the liquid crystal device comprises a chiral LC material, such as chiral nematic or chiral smectic, preferably a chiral nematic (cholesteric) liquid crystal (CLC) material. This device reflects circular polarised light of a specific wavelength. In addition such a device can be made using either a right-handed or left-handed cholesteric LC material. This provides an extra level of security if the device is examined with a polarisation selective viewer, where only one handedness of circular polarised light is recognised.

According to another a preferred embodiment the device comprises a thermochromic LC material. This device exhibits specific colour changes with varying temperature. This device also has the advantage that it can be treated at a later date in various ways to change its optical effect or inscribed information or to partially or completely invalidate the device after manufacture and during or after use. This is demonstrated further below.

According to another a preferred embodiment the device comprises a nematic or smectic LC material. This device produces interference colours when viewed through a linear polariser.

It is also possible to use any combination of the above materials to achieve corresponding combinations of the above described effects.

Preferred embodiments of the invention relate to a liquid crystal device wherein

the LC material comprises one or more polymerisable compounds, preferably one or more polymerisable mesogenic or liquid crystalline compounds,

the LC material comprises vitrified, polymerised or crosslinked LC material,

the LC material is a polymer gel,

the LC material is a polymer dispersed liquid crystal (PDLC),

the LC material essentially consists of unpolymerised LC material,

the LC material is a nematic, smectic or cholesteric LC material,

the LC material comprises a thermochromic material, and preferably consists essentially of thermochromic LC material,

both substrates are light transmissive,

at least one, preferably one, of the substrates is light reflective and/or comprises a reflective layer between the liquid crystal layer and the substrate,

at least one, preferably one, of the substrates is light absorptive and/or comprises an absorptive layer between the LC layer and the substrate,

the reflective substrate or layer comprises a metallic or metallized layer, hot stamping foil, holographic image, pearlescent or interference layer or pearlescent or interference pigments,

the reflective substrate or layer comprises one or more interference pigments, preferably provided in a light transmissive binder,

the reflective substrate or layer in addition to the interference pigments additionally comprises one or more further pigments or dyes,

at least one of the substrates comprises an alignment layer,

at least one of the substrates is a birefringent substrate and/or comprises a birefringent, polarising or optical phase shift or retardation layer,

the optical phase shift or retardation layer is a quarter wave retardation layer,

the optical retardation layer is a stretched or compressed film of isotropic polymer,

the polarising layer is a linear polariser,

the polarising layer is a circular polariser,

the linear polariser and/or optical phase shift or retardation layer comprise a vitrifed, polymerised or crosslinked LC material with uniform orientation.

The LC devices are preferably prepared by coating an LC material onto a substrate and laminating a second substrate on top of the LC material. The edges of the substrates are then sealed at least partially to form a pocket. Preferably the edges of the substrates are sealed completely. It is also possible to seal the edges only partially to leave one or more holes or openings that can remain open or optionally be sealed or closed at a later stage.

The LC material can be applied by conventional techniques known in the art, like for example spin or bar coating, or printing methods like offset-litho printing, gravure printing, screen printing or any other suitable printing method.

It is also possible to dissolve or disperse the LC material in a suitable solvent, like e.g. an organic solvent such as toluene or xylene.

After the LC material is covered with a second substrate, a pocket can be prepared by sealing e.g. with a hot wire. Other methods of sealing the edges include cutting and sealing with lasers or thermally polymerising the material to bond the laminate and substrate.

In addition to sealing the edges the substrates may also be bonded together by means of an adhesive.

As substrates for example plastic films or sheets can be used. At least one of the substrates should be transmissive for the light modulated by the LC material, in order to view the optical effects caused by the LC material. Preferably both substrates are light transmissive. When using polymerisable LC materials that are cured by actinic radiation, at least one substrate has to be transmissive for the actinic radiation used for the polymerisation. Isotropic or birefringent substrates can be used, isotropic substrates are preferred. Particularly preferred are plastic substrates, for example polyester films like polyethyleneterephthalate (PET), or polyvinylalcohol (PVA), polycarbonate (PC) or triacetylcellulose (TAC) films, especially preferably PET or TAC films. As birefringent substrates for example uniaxially stretched plastic films can be used. For example PET films are commercially available from ICI Corp. under the trade name Melinex.

For the LC material in principle any type of LC material known in the art can be used. LC materials with a high viscosity are especially preferred. Further preferred are LC materials that exhibit low tendency of crystallisation, and especially preferably do not readily crystallise, at the operating temperature. It is also possible to add further components to the LC material, such as components to increase the viscosity, like e.g. fused silica, organic oligomers or polymers, or components to suppress crystallisation.

In a preferred embodiment of the present invention the LC material comprises a polymerisable or crosslinkable material that is optionally polymerised or crosslinked at least partially during or after formation of the pocket. In this case the LC material preferably comprises a polymerisation initiator, like e.g. a thermal or photoinitiator. If a polymerisable LC material is used, the resulting LC device has higher mechanical strength and is more durable as the polymerised LC material provides an additional bonding of the laminate structure further to the sealed edges.

In another preferred embodiment the LC device comprises a reflective substrate. For the reflective substrate or layer in principle any reflective material can be used. The reflective layer is e.g. a metal or metallised layer, hologram, kinegram, hot stamping foil, pearlescent or interference pigment, or a layer comprising metal, metallised, pearlescent or interference pigments in a transparent binder.

Metal or metallised films or layers can be selected e.g of Al, Cu, Ni, Ag, Cr or alloys like e.g. Pt—Rh or Ni—Cr, or layers comprising one or more metal flakes dispersed in a light transmissive binder. Suitable metal flakes are e.g. flakes aluminium, gold or titan, or metal oxide flakes of e.g. Fe₂O₃ and/or TiO₂. Suitable pearlescent or interference pigments are e.g. mica, SiO₂, Al₂O₃, TiO₂ or glass flakes that are coated with one or more layers of e.g. titanium dioxide, iron oxide, titanium iron oxide or chrome oxide or combinations thereof, flakes comprising combinations of metal and metal oxide, metal flakes of e.g. aluminium coated with layers of iron oxide layers and/or silicium dioxide. It is also possible to use liquid crystal pigments or coatings comprising a polymerized or crosslinked liquid crystal material, e.g. cholesteric liquid crystal pigments as described in U.S. Pat. No. 5,364,557, U.S. Pat. No. 5,834,072, EP 0 601 483, WO 94/22976, WO 97/27251, WO 97/27252, WO 97/30136 or WO 9/02340, the entire disclosure of which is incorporated into this application by reference.

It is also possible to use a reflective substrate or layer comprising a hologram or kinegram, a holographic layer with an embossed, patterned or structured surface, or a layer of reflective holographic pigments. Light reflected by higher regions of the structured surface will interfer with light reflected by lower regions of the structured surface, thereby forming a holographic image.

In another preferred embodiment the LC device comprises a birefringent substrate, preferably a substrate that is an optical phase shift or retardation film or comprises an optical phase shift or retardation layer. The birefringent substrate causes an additional phase shift of the light and such provides additional optical effects, like for example an additional colour shift when viewing the device through a polariser. Preferably, the optical phase shift retardation layer or film is a quarter wave film (QWF) exhibiting a net retardation that is approximately 0.25 times the wavelength transmitted by the LC material.

As a retardation layer, it is possible to use uniaxially or biaxially stretched or compressed films of an isotropic polymer, like e.g. polyethylene terephthalate (PET), polyvinyl alcohol (PVA), polycarbonate (PC), di- or triacetyl cellulose (DAC, TAC). Especially preferred are PVA and PET films.

It is also possible to use a phase shift layer or retardation film comprising vitrified, polymerised or crosslinked liquid crystalline material with planar orientation, i.e. with the mesogenic groups of the liquid crystal material being oriented substantially parallel to the plane of the layer into a preferred direction. A retardation film comprising polymerised LC material with planar orientation is described in WO 98/04651, the entire disclosure of which is incorporated into this application by reference. It is also possible to use an optical retardation film comprising one or more layers of a polymerised liquid crystalline material with tilted orientation, i.e. with the mesogenic groups of the liquid crystal material are oriented at an oblique angle relative to the plane of the layer into a preferred direction. Such a QWF is described in WO 98/12584, the entire disclosure of which is incorporated into this application by reference.

The retardation layer can also comprise platelet shaped microflakes of a light retarding material as mentioned above. Thus, e.g. a retardation film of a stretched polymer or polymerised LC material can be ground into small flakes which are then incorporated into a light transmissive binder system to form a retardation layer.

In case the reflective substrate is a holographic layer as described above, the use of an additional phase shift or retardation layer leads to an to improved colour play and to an improved visibility of the holographic image, which is otherwise often difficult to recognize especially in a bright environment.

In another preferred embodiment the LC device comprises a light polarising substrate, like a linear or circular polariser, or a substrate that comprises a polarising layer. As linear polariser in principle all materials known in the art are suitable. Thus, e.g. standard linear absorption polarisers can be used comprising an uniaxially stretched polymer film of e.g. polyvinyl alcohol, or comprising a polymer film into which is incorporated a dichroic dye. It is also possible to use a linear polariser comprising a vitrified, polymerised or crosslinked liquid crystal (LC) material that exhibits macroscopically uniform planar orientation, i.e. with the mesogenic groups of the LC material being oriented substantially parallel to the plane of the layer into a preferred direction. The linear polariser can also be prepared e.g. by coating a layer of polymerisable LC material comprising a dye onto a substrate, aligning the LC material into planar orientation, i.e. so that the mesogenic groups are oriented parallel to the plane of the layer, polymerising or crosslinking the material by exposure to heat or actinic radiation. Linear polarisers made from polymerisable material by the above method are described in EP 0 397 263 (Philips), the entire disclosure of which is incorporated into this application by reference.

The LC material in the LC device is preferably a nematic, smectic or cholesteric LC material. Nematic LC materials are especially peferred.

In another preferred embodiment the LC material in the inventive device is a cholesteric LC (CLC) material. CLC materials with planar orientation show reflection of circular polarised light. By methods further described below it is possible to apply a hidden image or pattern to such a CLC device, which becomes visible only when viewed through a circular polariser. Alternatively, the CLC device will show a specific reflection colour when viewed on a black background. CLC materials are preferably used with dark or black substrates, however, reflective substrates can also be used. It is also possible to provide a CLC layer reflecting a broad wavelength band, preferably reflecting the entire visible spectrum. In this case no specific reflection colour, or a silver or gold reflection, is seen on a black background, and the pattern can be made visible by viewing through a circular polariser. Broad waveband CLC films or coatings and their preparation are described e.g. in EP 0 606 940, WO 97/35219, EP 0 982 605 and WO 99/02340, the entire disclosure of which is incorporated into this application by reference.

In a preferred embodiment of the present invention a photopolymerisable LC material is used and the inventive LC device is exposed to actinic radiation so that polymerisation will occur. For example an LC material can be used that polymerises upon exposure to UV light. This will affect the visible affect especially in case of thermochromic LC materials. Incorporation of a photoinitiator, e,g, a UV photoinitator, into the LC material allows a design or pattern to be fixed into the device e.g. by curing through a photomask.

The amount of photoinitiator can be limited, and/or a polymerisation inhibitor can be added, in order to prevent unwanted spontaneous polymerisation e.g. initiated by daylight. This can also be achieved by using substrates comprising an absorbing film or layer that absorbs actinic radiation initiating the polymerisation, e.g. a UV absorbing layer in case of LC material that polymerises by exposure to UV light.

On the other hand, by increasing the amount of photoinitiator in the LC material or selecting a photoinitiator absorbing visible light, the spontaneous polymerisation that arises from exposure of the device to daylight can be exploited to impart a limited lifetime to the device.

The LC device according to this preferred embodiment can be provided with a pattern or image that is visible or a pattern that is invisible when viewed under unpolarised light and becomes visible only when viewed through a polariser. Such a pattern can for example be prepared by the following method:

A polymerisable thermochromic LC material containing a UV photoinitiator is used and an LC device in the shape of a pocket prepared as described above. A black design or photomask is placed over the pocket and the pocket is exposed to UV light. Alternatively to the black design a UV absorbing design or photomask can be used. This cures the LC material in the uncovered part of the pocket and fixes in a specific colour in the shape of the design or photomask. For example, if the thermochromic LC material is cured in its smectic phase underlying the cholesteric phase, it is fixed in the colourless smectic state and the black background in the shape of the design or photomaks is seen in the uncovered part. The same effect can also be achieved with a cholesteric mixture reflecting in the UV or infrared region. In the part of the pocket that was covered by the design or photomask the LC material retains its thermochromic properties and shows a colour change when heated and/or pressed.

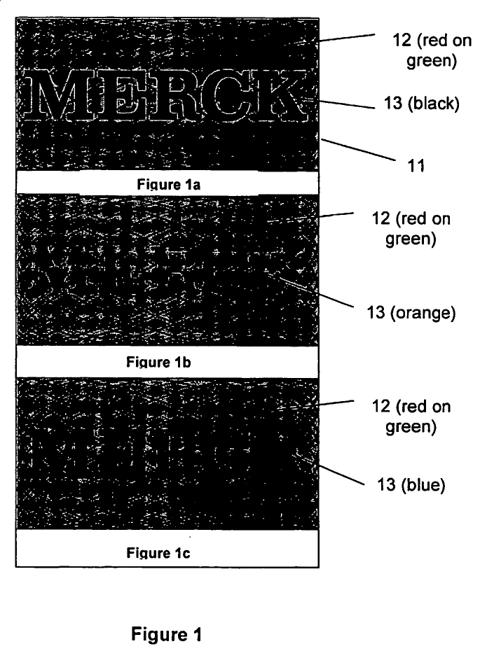

By raising the temperature and selectively curing the LC material, for example by irradiation with a laser or using photomask technology, a design can be written in a colour which is then fixed. By changing the temperature and partial curing a second design can be fixed. This process can be repeated many times to give a range of fixed colours, optionally leaving an uncured region still showing thermochromic behaviour. This is exemplarily depicted in FIGS. 1a-1c, showing a device 11 according to the present invention at room temperature (1a) and after warming to a second (1b) and third temperature (1c) above room temperature. The device comprises a cured background region (green) 12 with a first pattern (red), both being cured at different temperatures to give different fixed colours, and further comprises a region defined by the pattern 13 comprising uncured thermochromic LC material with black colour at room temperature. When the device is heated above room temperature, the uncured design 13 shows a colour change to orange (FIG. 1b) and blue (FIG. 1c).

Exposure to strong UV light or another suitable wavelength can then destroy the thermochromic effect in the uncured region of the device to invalidate the device.

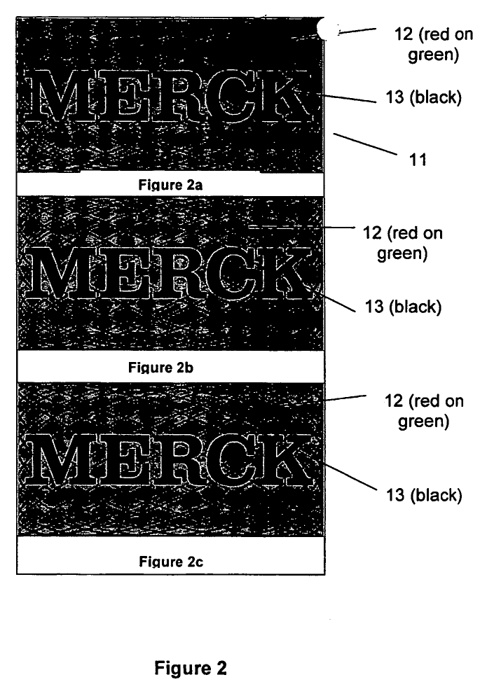

This is exemplarily depicted in FIGS. 2a-2c, showing the device 11 of FIG. 1, wherein the colour of the previously uncured region 13 has been fixed by polymerisation at room temperature (FIG. 2a) and does not show a colour change when being heated (FIGS. 2b, 2c).

In another preferred embodiment the LC device is prepared using a polymerisable nematic LC material, having birefringent properties which generate colours when viewed through a linear polariser. For example a coating of polymerisable nematic LC material is made on a reflective substrate and laminated with another substrate. A fixed design is then introduced in either the nematic or isotropic phase of the LC material by photopolymerisation at a suitable temperature. The birefringent properties will cause a coloured effect to be seen when viewed through a linear polariser which appears and disappears as the polariser is rotated.

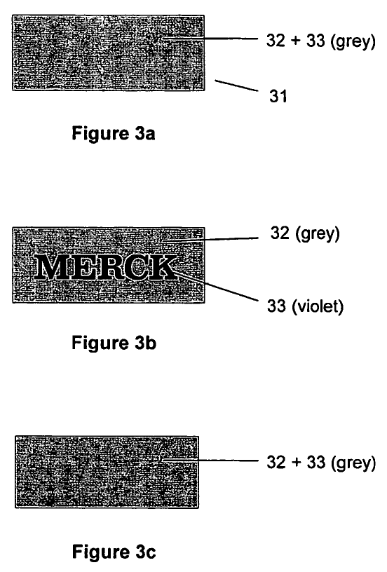

This is exemplarily depicted in FIGS. 3a-3c, showing a device 31 prepared as described above from a polymerisable nematic LC material, wherein the region 32 has been cured in the isotropic phase of the LC material using a photomask with the design 33. The region defined by the pattern 33 thus comprises uncured nematic LC material. FIG. 3a shows the device viewed without a polariser, no pattern can be seen. FIG. 3b shows the device viewed with a polariser at a temperature in the nematic phase of the LC material, the nematic region 33 is visible on the isotropic background 32. FIG. 3c shows the device viewed with a polariser at a temperature in the isotropic phase of the LC material, both region 32 and 33 are isotropic and no pattern can be seen.

If the nematic-isotropic phase transition temperature is low enough, e.g. 30° C. or lower, the pattern 33 can even be made to disappear when heated by e.g. a warm finger.

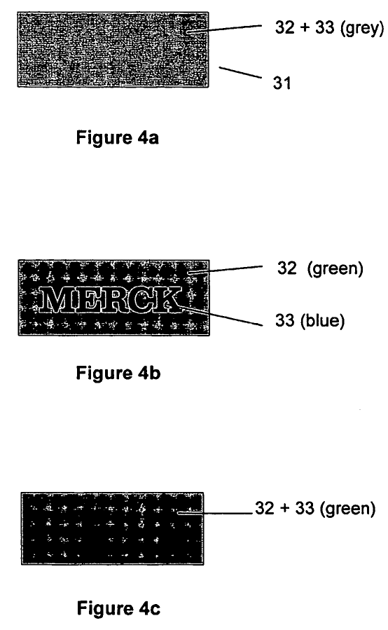

The substrates can be birefringent or non-birefringent. In case a birefringent substrate is used, this will yield a multicolour effect when viewed through a polariser, as exemplarily depicted in FIGS. 4a-4c, showing the device 31 with regions 32 and 33 prepared from the same LC material and under the same conditions as described in FIGS. 3a-3c, the only difference being that the substrate on the viewer side is birefringent. This provides an additional colour effect when the device is viewed with a polariser (FIGS. 4b, 4c).

In the device comprising LC nematic material, too, exposure of the uncured region to strong UV light or another suitable wavelength can invalidate the thermal effect, so that the device appears the same when viewed at different temperatures (see FIGS. 3b, 3c and 4b, 4c respectively).

As described above it is possible to impart a second design different from a first design into an inventive LC device. Thus, the device can be invalidated at a later date, e.g. by including the term ‘void’ or a similar term in the second design. This provides a security device which can be prepared with a secure design at the point of manufacture and invalidated at point of sale. This method also allows the writing of secure information onto documents, like e.g. serial numbers on bank notes, images on credit cards or passports and the like.

If very thin substrates are used, the devices are easily ruptured. These devices are suitable as a tamper proof or evidence.

The following types of devices are especially preferred:

| | |
|---|---|
| 1) LC material: | chiral nematic (cholesteric) LC (CLC) |
| base substrate: | Black |
| top laminate: | Clear |
| effect: | thermochromic effect, angular colour |
| | dependency |
| possible application: | simple, obvious security, information |
| | storage or decorative feature for public |
| | use; colour play can be tailor made |
| 2) LC material: | CLC |
| base substrate: | Black |
| top laminate: | clear, non-birefringent |
| effect: | thermochromic; reflects single type |
| | (handedness) of circular polarised light |
| possible application: | simple, obvious security, information |
| | storage or decorative feature with |
| | additional hidden security feature for |
| | public use; colour play can be tailor made |
| 3) LC material: | CLC |
| base substrate: | Black |
| top laminate: | Printed |
| effect: | thermochromic effect with visible design |
| possible application: | simple, obvious security, information |
| | storage or decorative feature with |
| | additional hidden feature for public use; |
| | colour play can be tailor made |
| 4) LC material: | polymerisable CLC |
| base substrate: | Black |
| top laminate: | clear, designed |
| effect: | cured to fix design |
| possible application: | writable device in particular for |
| | information storage or security markings |
| 5) LC material: | nematic LC |
| base substrate: | Metaliised |
| top laminate: | clear, non-birefringent |
| effect: | interference colour when viewed with |
| | polarised light |
| possible application: | hidden decorative or security feature; |
| | colour depends on coating thickness |

The inventive LC devices can be used for direct application, or as holograms or hot stamping foils for decorative or security applications, to authenticate and prevent counterfeiting of documents of value, for identification of hidden images, informations or patterns or for optical information storage. They can be applied to consumer products or household objects, car bodies, foils, packing materials, clothes or woven fabric, incorporated into plastic, or applied as security markings or threads on documents of value like banknotes, credit cards or ID cards, national ID documents, licenses or any product with money value, like stamps, tickets, shares, cheques etc.

The devices according to the present invention can be used as self-standing devices or by application to other documents or items. They can for example be prepared on a self-adhesive label as substrate.

For decorative or security applications the LC devices according to the invention can be directly applied to objects. They can also be applied to adhesive labels for ease of application to a wide range of items. It is also possible to manufacture an inventive LC device using adhesive substrates that stick to an object without the need of further fixing means or methods.

The LC devices according to the present invention are especially suitable for use in hot stamping foils and holographic foils for the preparation of security markings and security threads. Holographic layers are described e.g. in U.S. Pat. No. 4,588,664, hot stamping foils comprising liquid crystal material and their preparation are described in the patent application GB 2 357 061, the entire disclosure of which is incorporated into this application by reference.

The LC devices according to the present invention are especially envisaged for applications in the area of security. Specific applications are in the areas of high value documents such as passports, identification cards and driving licenses. The inventive device can be either included in the laminate structure of the document or adhesively bound to the document.

Further applications are in paper documents such as bank notes, share certificates, cheques and event tickets. The inventive LC devices can be woven into the paper, adhesively bound to the paper or included as a transparent “watermark” area in the paper.

Another area of application is as a layer in laminated plastic devices such as credit cards.

Another area of application is as adhesive labels or tags for use as brand protection devices.

The above examples are not exhaustive but are intended to exemplarily demonstrate the wide range of possible applications.

Suitable cholesteric or thermochromic LC mixtures are known to the skilled person. Especially suitable and preferred mixtures for the devices according to the present invention are disclosed for example in the following documents: Nonpolymerizable CLC mixtures in GB 2 279 659, nonpolymerizable thermochromic CLC mixtures in GB 2 280 681 and GB 2 355 987, polymerizable CLC mixtures in U.S. Pat. No. 5,560,864, EP 0 794 991, U.S. Pat. No. 5,746,940, GB 2 298 202, WO 97/30136, WO 97/35219, EP 0 982 605 and GB 2 357 291, polymerizable thermochromic CLC mixtures in GB 2 315 760, GB 2 330 360 and GB 2 329 900, and polymerizable or nonpolymerizable CLC mixtures in WO 98/00428, GB 2 328 207, EP 0 992 485.

In case the LC device contains non-polymerizable LC material, this is preferably a liquid crystalline mixture consisting of 2 to 25, preferably 3 to 15 compounds, very preferably low molecular weight liquid crystalline compounds selected from nematic or nematogenic substances, for example from the known classes of the azoxybenzenes, benzylidene-anilines, biphenyls, terphenyls, phenyl or cyclohexyl benzoates, phenyl or cyclohexyl esters of cyclohehexanecarboxylic acid, phenyl or cyclohexyl esters of cyclohexylbenzoic acid, phenyl or cyclohexyl esters of cyclohexylcyclohexanecarboxylic acid, cyclohexylphenyl esters of benzoic acid, of cyclohexanecarboxylic acid and of cyclohexylcyclohexanecarboxylic acid, phenylcyclohexanes, cyclohexylbiphenyls, phenylcyclohexylcyclohexanes, cyclohexylcyclohexanes, cyclohexylcyclohexenes, cyclohexylcyclohexylcyclohexenes, 1,4-bis-cyclohexylbenzenes, 4,4′-bis-cyclohexylbiphenyls, phenyl- or cyclohexylpyrimidines, phenyl- or cyclohexylpyridines, phenyl- or cyclohexylpyridazines, phenyl- or cyclohexyldioxanes, phenyl- or cyclohexyl-1,3-dithianes, 1,2-diphenyl-ethanes, 1,2-dicyclohexylethanes, 1-phenyl-2-cyclohexylethanes, 1-cyclohexyl-2-(4-phenylcyclohexyl)-ethanes, 1-cyclohexyl-2-biphenyl-ethanes, 1-phenyl2-cyclohexylphenylethanes, optionally halogenated stilbenes, benzyl phenyl ether, tolanes, substituted cinnamic acids and further classes of nematic or nematogenic substances. The 1,4-phenylene groups in these compounds may also be laterally mono- or difluorinated.

The liquid crystalline mixture of this preferred embodiment is based on the achiral compounds of this type.

The most important compounds that are posssible as components of these liquid crystalline mixtures can be characterized by the following formula

R′-L′-G′-E-R″

wherein L′ and E, which may be identical or different, are in each case, independently from one another, a bivalent radical from the group formed by -Phe-, -Cyc-, -Phe-Phe-, -Phe-Cyc-, -Cyc-Cyc-, -Pyr-, -Dio-, -B-Phe- and -B-Cyc- and their mirror images, where Phe is unsubstituted or fluorine-substituted 1,4-phenylene, Cyc is trans-1,4-cyclohexylene or 1,4-cyclohexenylene, Pyr is pyrimidine-2,5-diyl or pyridine-2,5-diyl, Dio is 1,3-dioxane-2,5-diyl abd B is 2-(trans-1,4-cyclohexyl)ethyl, pyrimidine-2,5-diyl, pyridine-2,5-diyl or 1,3-dioxane-2,5-diyl.

G′ in these compounds is selected from the following bivalent groups —CH═CH—, —N(O)N—, —CH═CY—, —CH═N(O)—, —C≡C—, —CH₂—CH₂—, —CO—O—, —CH₂—O—, —CO—S—, —CH₂—S—, —CH═N—, —COO-Phe-COO— or a single bond, with Y being halogen, preferably chlorine, or —CN.

R′ and R″ are, in each case, independently of one another, alkyl, alkenyl, alkoxy, alkenyloxy, alkanoyloxy, alkoxycarbonyl or alkoxycarbonyloxy with 1 to 18, preferably 3 to 12 C atoms, or alternatively one of R′ and R″ is F, CF₃, OCF₃, Cl, NCS or CN.

In most of these compounds R′ and R″ are, in each case, independently of each another, alkyl, alkenyl or alkoxy with different chain length, wherein the sum of C atoms in nematic media generally is between 2 and 9, preferably between 2 and 7.

Many of these compounds or mixtures thereof are commercially available. All of these compounds are either known or can be prepared by methods which are known per se, as described in the literature (for example in the standard works such as Houben-Weyl, Methoden der Organischen Chemie [Methods of Organic Chemistry], Georg-Thieme-Veriag, Stuttgart), to be precise under reaction conditions which are known and suitable for said reactions. Use may also be made here of variants which are known per se, but are not mentioned here.

In another preferred embodiment of the invention the LC material is a polymerisable or crosslinkable material, or comprises an LC polymer. LC side chain polymers or LC main chain polymers may be used. LC side chain polymers are especially preferred. For example, LC side chain polymers comprising a polyacrylate, polymethacrylate, polysiloxane, polystyrene or epoxide backbone with laterally attached mesogenic side chains can be used. The polymer may also comprise side chains with reactive groups that can be crosslinked after or during evaporation of the solvent. If polymers with a glass temperature that is higher than ambient temperature are used, evaporation of the solvent leaves a solid LC polymer film. The LC polymer may also be subjected to heat treatment after application to the substrate.

Preferably a polymerisable LC material is used comprising at least one polymerisable mesogenic compound having one polymerisable functional group and at least one polymerisable mesogenic compound having two or more polymerisable functional groups.

In another preferred embodiment the polymerisable LC material comprises polymerisable mesogenic compounds having two or more polymerisable functional groups (di- or multireactive or di-or multifunctional compounds). Upon polymerisation of such a mixture a three-dimensional polymer network is formed, which is self-supporting and shows a high mechanical and thermal stability and a low temperature dependence of its physical and optical properties. By varying the concentration of the multifunctional mesogenic or non mesogenic compounds the crosslink density of the polymer film and thereby its physical and chemical properties such as the glass transition temperature, which is also important for the temperature dependence of the optical properties of the polymerised film, the thermal and mechanical stability or the solvent resistance can be tuned easily.

The polymerisable mesogenic mono-, di- or multireactive compounds can be prepared by methods which are known per se and which are described, for example, in standard works of organic chemistry such as, for example, Houben-Weyl, Methoden der organischen Chemie, Thieme-Verlag, Stuttgart. Typical examples are described for example in WO 93/22397; EP 0 261 712; DE 19504224; DE 4408171 and DE 4405316, the entire disclosure of which is incorporated into this application by reference. The compounds disclosed in these documents, however, are to be regarded merely as examples that do not limit the scope of this invention.

Examples representing especially useful monoreactive polymerisable mesogenic compounds are shown in the following list of compounds, which should, however, be taken only as illustrative and is in no way intended to restrict, but instead to explain the present invention:

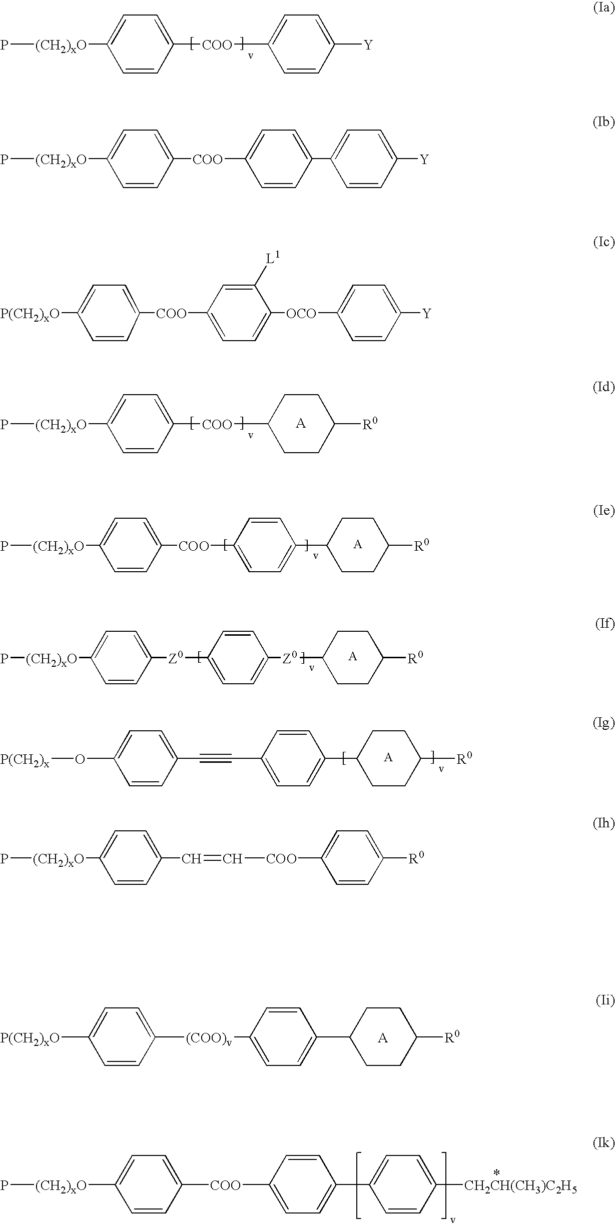

Examples of useful direactive polymerisable mesogenic compounds are shown in the following list of compounds, which should, however, be taken only as illustrative and is in no way intended to restrict, but instead to explain the present invention

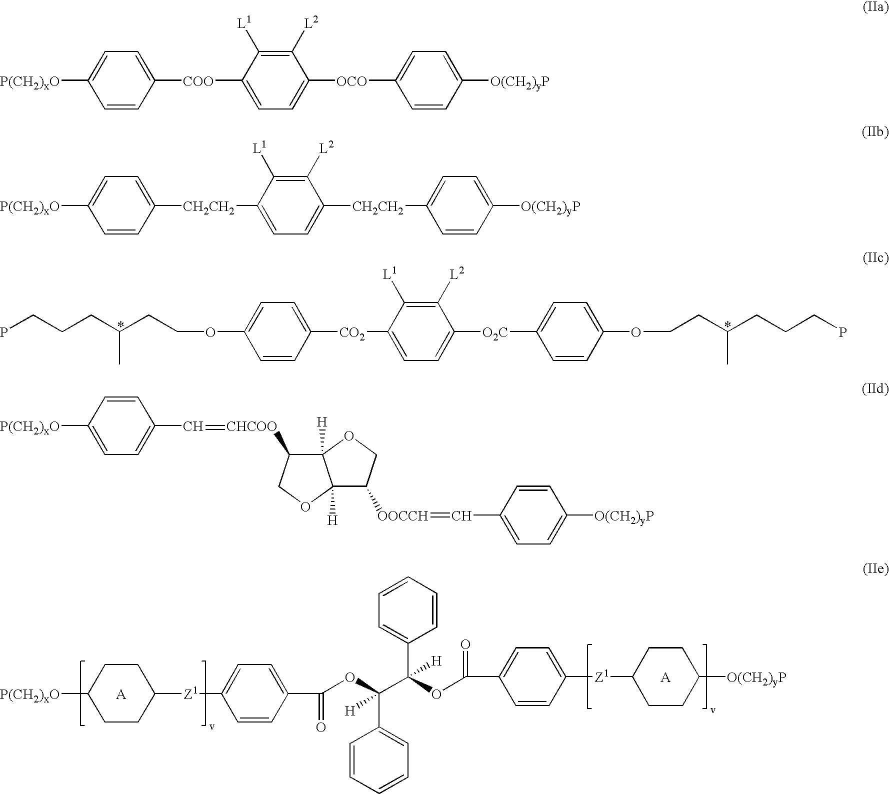

In the above formulae, P is a polymerisable group, preferably an acryl, methacryl, vinyl, vinyloxy, propenyl ether, epoxy or stytryl group, x and y are each independently 1 to 12, A is 1,4-phenylene that is optionally mono- di or trisubstituted by L¹ or 1,4-cyclohexylene, v is 0 or 1, Z⁰ is —COO—, —OCO—, —CH₂CH₂— or a single bond, Y is a polar group, Ter is a terpenoid radical like e.g. menthyl, Chol is a cholesteryl group, R⁰ is an unpolar alkyl or alkoxy group, and L¹ and L² are each independently H, F, Cl, CN or an optionally halogenated alkyl, alkoxy, alkylcarbonyl, alkoxycarbonyl or alkoxycarbonyloxy group with 1 to 7 C atoms.

The term ‘polar group’ in this connection means a group selected from F, Cl, CN, NO₂, OH, OCH₃, OCN, SCN, an optionally fluorinated carbonyl or carboxyl group with up to 4 C atoms or a mono- oligo- or polyfluorinated alkyl or alkoxy group with 1 to 4 C atoms. The term ‘unpolar group’ means an alkyl group with 1 or more, preferably 1 to 12 C atoms or an alkoxy group with 2 or more, preferably 2 to 12 C atoms.

In case of inventive devices comprising CLC or thermochromic LC materials, the LC material preferably comprises a nematic or smectic host material as described above and one or more chiral dopants that induce a helical twist in the host material. The chiral dopants can be polymerisable or not. They can be mesogenic or liquid crystal compounds, but do not necessarily have to be liquid crystalline.

Especially preferred are chiral dopants with a high helical twisting power (HTP), in particular those disclosed in WO 98/00428. Further typically used chiral dopants are e.g. the commercially available S 1011, R 811 or CB 15 (from Merck KGaA, Darmstadt, Germany).

Vey preferred are chiral dopants selected from the following formulae

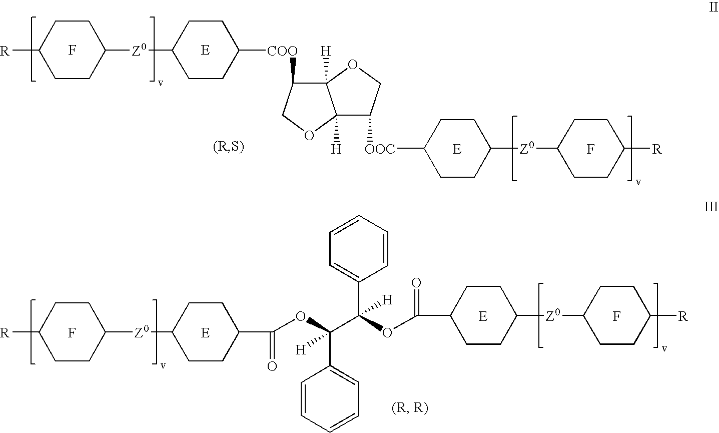

including the (R,S), (S,R), (R,R) and (S,S) enantiomers not shown, wherein E and F have each independently one of the meanings of A given above, v is 0 or 1, Z⁰ is —COO—, —OCO—, —CH₂CH₂— or a single bond, and R is alkyl, alkoxy, carbonyl or carbonyloxy with 1 to 12 C atoms.

The compounds of formula II are described in WO 98/00428, the compounds of formula III synthesis are described in GB 2,328,207, the entire disclosure of which is incorporated into this application by reference.

The above chiral compounds of formula II and III exhibit a very high helical twisting power (HTP), and are therefore particularly useful for the purpose of the present invention.

Polymerisable chiral compounds are preferably selected from the above formulae Ik to Ip, and IIc to IIe. It is also possible to use compounds of formula Ia to Ii wherein R⁰ or Y comprise a chiral C atom.

The amount of chiral dopants in the LC material is preferably less than 15%, in particular from 0.01 to 10%, very preferably from 0.1 to 5% by weight of the total LC material (without the solvent).

Polymerisation of the polymerisable LC material takes place by exposing it to heat or actinic radiation. Actinic radiation means irradiation with light, like UV light, IR light or visible light, irradiation with X-rays or gamma rays or irradiation with high energy particles, such as ions or electrons. Preferably polymerisation is carried out by UV irradiation. As a source for actinic radiation for example a single UV lamp or a set of UV lamps can be used. When using a high lamp power the curing time can be reduced. Another possible source for actinic radiation is a laser, like e.g. a UV laser, an IR laser or a visible laser.

The polymerisation is carried out in the presence of an initiator absorbing at the wavelength of the actinic radiation. For example, when polymerising by means of UV light, a photoinitiator can be used that decomposes under UV irradiation to produce free radicals or ions that start the polymerisation reaction. When curing polymerisable mesogens with acrylate or methacrylate groups, preferably a radical photoinitiator is used, when curing polymerisable mesogens vinyl and epoxide groups, preferably a cationic photoinitiator is used. It is also possible to use a polymerisation initiator that decomposes when heated to produce free radicals or ions that start the polymerisation. As a photoinitiator for radical polymerisation for example the commercially available Irgacure 651, Irgacure 184, Darocure 1173 or Darocure 4205 (all from Ciba Geigy AG) can be used, whereas in case of cationic photopolymerisation the commercially available UVI 6974 (Union Carbide) can be used. The polymerisable LC material preferably comprises 0.01 to 10%, very preferably 0.05 to 5%, in particular 0.1 to 3% of a polymerisation initiator. UV photoinitiators are preferred, in particular radicalic UV photoinitiators.

The curing time is dependening, inter alia, on the reactivity of the polymerisable mesogenic material, the thickness of the coated layer, the type of polymerisation initiator and the power of the UV lamp. The curing time according to the invention is preferably not longer than 10 minutes, particularly preferably not longer than 5 minutes and very particularly preferably shorter than 2 minutes. For mass production short curing times of 3 minutes or less, very preferably of 1 minute or less, in particular of 30 seconds or less, are preferred.

The inventive polymerisable liquid crystalline mixtures can additionally comprise one or more other suitable components such as, for example, catalysts, sensitizers, stabilizers, inhibitors, co-reacting monomers, surface-active compounds, lubricating agents, wetting agents, dispersing agents, hydrophobing agents, adhesive agents, flow improvers, defoaming agents, deaerators, diluents, reactive diluents, auxiliaries, colourants, dyes or pigments.

In particular the addition of stabilizers is preferred in order to prevent undesired spontaneous polymerisation of the polymerisable material for example during storage. As stabilizers in principal all compounds can be used that are known to the skilled in the art for this purpose. These compounds are commercially available in a broad variety. Typical examples for stabilizers are 4-ethoxyphenol or butylated hydroxytoluene (BHT).

Other additives, like e.g. chain transfer agents, can also be added to the polymerisable LC material in order to modify the physical properties of the resulting polymer film. When adding a chain transfer agent, such as monofunctional thiol compounds like e.g. dodecane thiol or multifunctional thiol compounds like e.g. trimethylpropane tri(3-mercaptopropionate), to the polymerisable material, the length of the free polymer chains and/or the length of the polymer chains between two crosslinks in the inventive polymer film can be controlled. When the amount of the chain transfer agent is increased, the polymer chain length in the obtained polymer film is decreasing.

It is also possible, in order to increase crosslinking of the polymers, to add up to 20% of a non mesogenic compound with two or more polymerisable functional groups to the polymerisable LC material alternatively or in addition to the di- or multifunctional polymerisable mesogenic compounds to increase crosslinking of the polymer. Typical examples for difunctional non mesogenic monomers are alkyldiacrylates or alkyldimethacrylates with alkyl groups of 1 to 20 C atoms. Typical examples for non mesogenic monomers with more than two polymerisable groups are trimethylpropanetrimethacrylate or pentaerythritoltetraacrylate.

In another preferred embodiment the mixture of polymerisable material comprises up to 70%, preferably 3 to 50% of a non mesogenic compound with one polymerisable functional group. Typical examples for monofunctional non mesogenic monomers are alkylacrylates or alkylmethacrylates.

It is also possible to add, for example, a quantity of up to 20% by weight of a non polymerisable liquid-crystalline compound to adapt the optical properties of the resulting polymer film.

The polymerisation is preferably carried out in the liquid crystal phase of the polymerisable LC material. Therefore, preferably polymerisable mesogenic compounds or mixtures with low melting points and broad liquid crystal phase ranges are used. The use of such materials allows to reduce the polymerisation temperature, which makes the polymerisation process easier and is a considerable advantage especially for mass production. The selection of suitable polymerisation temperatures depends mainly on the clearing point of the polymerisable material and inter alia on the softening point of the substrate. Preferably the polymerisation temperature is at least 30 degrees below the clearing temperature of the polymerisable mesogenic mixture. Polymerisation temperatures below 120° C. are preferred. Especially preferred are temperatures below 90° C., in particular temperatures of 60° C. or less.

Without further elaboration, it is believed that one skilled in the art can, using the preceding description, utilize the present invention to ist fullest extent. The following examples are, therefore, to be construed as merely illustrative and not limitative of the remainder of the disclosure in any way whatsoever.

In the foregoing and in the following examples, unless otherwise indicated, all temperatures are set forth uncorrected in degrees Celsius and all parts and percentages are by weight.

### EXAMPLE 1

The following polymerisable thermochromic LC mixture is prepared

| | |
|---|---|
| Compound (A) | 11.21% |
| compound (B) | 16.08% |
| compound (C) | 4.99% |
| compound (D) | 12.24% |
| compound (E) | 55.47% |

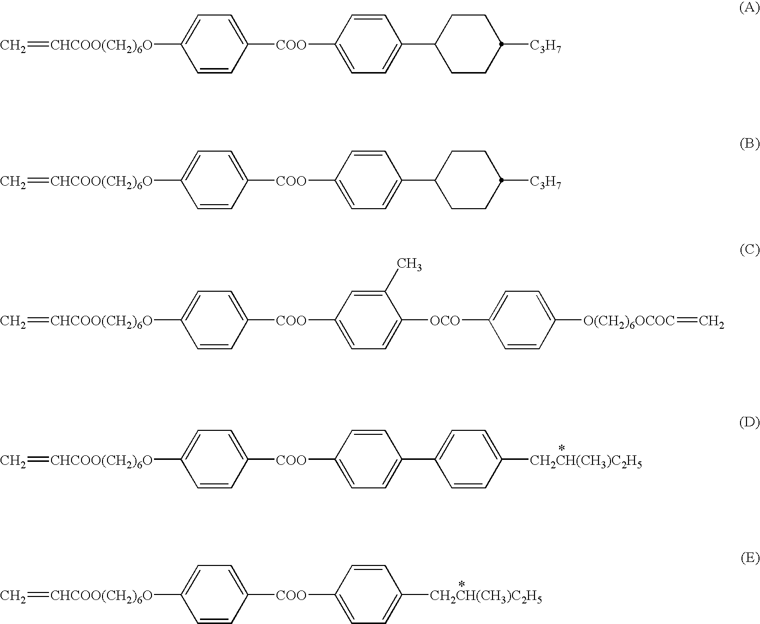

Compounds (A) and (B) and their preparation are described in GB 2,280,445. Compound (C) can be prepared according to or in analogy to the methods described in D. J. Broer et al., Makromol. Chem. 190, 3201-3215 (1989). Compound (D) and (E) and their preparation are described in DE 195 04 224.

The mixture is heated to the isotropic phase to ensure uniformity of composition and coated onto a black metallised PET substrate (12 μm) with a yellow Kbar to give a 6 μm thick film. A more uniform coating is obtained if the mixture is dissolved in a solvent, like for example xylene, and coated.

The coated film is laminated with a clear PET film (12 μm). Sealed pockets are formed by pressing a hot wire on the laminate structure to seal the edges. Pressing or heating the pockets or selected areas of the pockets result in a colour change from clear through red and green to a greenish blue. The speed of the colour response is fast due to the low thermal capacity of the pockets.

If the film is too thick a milky appearance arises because of bad alignment. If the film is too thin poor colour is produced. Best results are obtained with a film thickness of 5 to 7 μm.

Mixtures prepared from nematic liquid crystal material can also be prepared analoguously and pockets prepared as described above.

### EXAMPLE 2

The following polymerisable thermochromic LC mixture is prepared

| | |
|---|---|
| Compound (A) | 10.46% |
| compound (B) | 16.71% |
| compound (C) | 5.30% |
| compound (D) | 16.09% |
| compound (E) | 51.11% |
| Irgacure | 0.33% |

Irgacure is a commercially available photoinitiator from Ciba AG (Basel, Switzerland).

The mixture is dissolved in xylene, coated onto a black substrate and laminated with a clear PET film. A pocket is prepared by sealing with a hot wire. A black design or photomask is placed over the sealed pocket exposed to UV radiation for 5 seconds. This cures the uncovered part of the pocket. Alternatively to the black design a UV absorbing design or photomask can be used.

As a result, in the uncovered part of the pocket a fixed image in black colour in the shape of the design or photomask is seen (where the black substrate is visible through the clear, cured LC mixture), whereas the covered part of the pocket retains is thermochromic properties and shows a colour change when heated and or pressed.

The preceding examples can be repeated with similar success by substituting the generically or specifically described reactants and/or operating conditions of this invention for those used in the preceding examples. From the foregoing description, one skilled in the art can easily ascertain the essential characteristics of this invention, and without departing from the spirit and scope thereof, can make various changes and modifications of the invention to adapt it to various usages and conditions.

1. Liquid crystal device comprising a liquid crystal material provided between two substrates the edges of which are sealed at least partially to form a pocket.

2. Liquid crystal device according to claim 1, wherein the liquid crystal material comprises one or more polymerisable compounds.

3. Liquid crystal device according to claim 1 or 2, wherein the liquid crystal material comprises vitrified, polymerised or crosslinked liquid crystal material.

4. Liquid crystal device according to any of claims 1 to 3, wherein the liquid crystal material essentially consists of unpolymerised liquid crystal material.

5. Liquid crystal device according to any of claims 1 to 4, wherein the liquid crystal material is a nematic, smectic or cholesteric liquid crystal material.

6. Liquid crystal device according to any of claims 1 to 5, wherein the liquid crystal material is a thermochromic material.

7. Liquid crystal device according to any of claims 1 to 6, wherein one of the substrates is light reflective or light absorptive.

8. Liquid crystal device according to claim 7, wherein one of the substrates is light reflective and comprises a metallic or metallized layer, hot stamping foil, holographic image, pearlescent or interference layer or pearlescent or interference pigments.

9. Liquid crystal device according to any of claims 1 to 8, wherein at least one of the substrates comprises an alignment layer.

10. Liquid crystal device according to any of claims 1 to 9, wherein at least one of the substrates is a birefringent substrate and/or comprises a birefringent, polarising or optical phase shift or retardation layer.

11. Use of a liquid crystal device according to any of claims 1 to 10 in decorative, cosmetic, diagnostic or security applications or for optical information storage.

12. Security marking or device comprising a liquid crystal device according to any of claims 1 to 10.
